(19) United States
(12) Patent Application Publication
(10) Pub. No.: US 2020/0242085 A1
(43) Pub. Date: Jul. 30, 2020

(54) FILE SHARING METHOD, A DEVICE, AND A COMPUTER READABLE MEDIUM

(71) Applicant: SHANGHAI ZHANGMEN SCIENCE AND TECHNOLOGY CO., LTD., Shanghai (CN)

(72) Inventor: Tiyuan SHI, Shanghai (CN)

(73) Assignee: SHANGHAI ZHANGMEN SCIENCE AND TECHNOLOGY CO., LTD., Shanghai (CN)

(21) Appl. No.: 16/847,617

(22) Filed: Apr. 13, 2020

Related U.S. Application Data
(63) Continuation of application No. PCT/CN2018/109736, filed on Oct. 10, 2018.

(30) Foreign Application Priority Data
Oct. 11, 2017 (CN) 201710943211.2

(51) Int. Cl. G06F 16/17; G06F 16/182; G06F 16/28; H04L 29/08; G06K 9/62

(52) U.S. Cl. CPC G06F 16/1734; G06F 16/1824; G06K 9/6217; H04L 67/06; G06F 16/285

(57) ABSTRACT

A file sharing method includes: obtaining feature information of an already-happened event; clustering target files according to the feature information of the already-happened event to obtain one or more target file groups, wherein each target file group includes at least one target file; and sending at least one target file group and/or at least one target file in the one or more target file groups. Furthermore, a device and a computer readable medium are provided. In this way, a user can quickly select a target file related to the already-happened event, which enhances fun of user interaction and improves user experience.

### CROSS REFERENCE TO THE RELATED APPLICATIONS

This application is the continuation application of International Application No. PCT/CN2018/109736, filed on Oct. 10, 2018, which is based upon and claims priority to Chinese Patent Application No. 201710943211.2, filed on Oct. 11, 2017, the entire contents of which are incorporated herein by reference.

### TECHNICAL FIELD

The present disclosure relates to the field of computer technologies, and in particular, to a file sharing method, a device, and a computer readable medium.

### BACKGROUND

With the rapid development of electronic technologies, mobile terminals (such as a smartphone and a tablet computer) usually can be used to take photos. Moreover, the mobile terminals are providing a better photographing effect, and more people use the mobile terminals to take photos.

For example, a smartphone is used to take photos with friends in a party. Alternatively, a smartphone is used to take photos with beautiful scenery and friends in travel. With an increasing quantity of photos, a user needs to consume quite a lot of time and effort to select a photo to share it with a friend. When sharing a same group of photos with different friends, the user even needs to repeatedly select the group of photos from a photo gallery to share them with the different friends.

A file sharing method is urgently needed to simplify selection operations for the user, enhance fun of user interaction, and improve user experience.

### SUMMARY

In view of this, embodiments of the present disclosure provide a file sharing method, a device, and a computer readable medium, to resolve a problem of complexity and repetition in file sharing operations in the related art.

The following technical solutions are used in the embodiments of the present disclosure:

An embodiment of the present disclosure provides a file sharing method, including:

obtaining feature information of an already-happened event;

clustering target files according to the feature information of the already-happened event to obtain one or more target file groups, where each target file group includes at least one target file; and

sending at least one target file group and/or at least one target file in the one or more target file groups.

An embodiment of the present disclosure further provides a computer readable medium, storing a computer readable instruction, where the computer readable instruction is executable by a processor to perform the following steps:

obtaining feature information of an already-happened event;

clustering target files according to the feature information of the already-happened event to obtain one or more target file groups, where each target file group includes at least one target file; and

sending at least one target file group and/or at least one target file in the one or more target file groups.

An embodiment of the present disclosure further provides a device for processing information at a user equipment end, including a memory configured to store a computer program instruction and a processor configured to execute the program instruction, where when executed by the processor, the computer program instruction triggers the device to perform the following steps:

obtaining feature information of an already-happened event;

clustering target files according to the feature information of the already-happened event to obtain one or more target file groups, where each target file group includes at least one target file; and

sending at least one target file group and/or at least one target file in the one or more target file groups.

The at least one technical solution used in the embodiments of the present disclosure can achieve the following beneficial effects: Target files are clustered according to feature information of an already-happened event to obtain one or more target file groups, so that a target file in the one or more target file groups is related to the already-happened event. Then a target file or a target file group to be sent is determined from the target file groups obtained through the clustering. In this way, a user can quickly select a target file related to the already-happened event, which enhances fun of user interaction and improves user experience. In addition, all target files in a target file group can be directly selected through a single operation, which simplifies operations for the user to select the target files, saves time for the user, and further improves user experience.

### BRIEF DESCRIPTION OF THE DRAWINGS

The accompanying drawings described herein are used for providing further understanding for the present application and constitute a part of the present application. Exemplary embodiments of the present application and descriptions thereof are used for explaining the present application and do not constitute an improper limitation to the present application. In the accompanying drawings:

FIG. 1 is a flowchart of a file sharing method according to an embodiment of the present invention;

FIG. 2 is a schematic diagram of a clustering result when a user A chats with a target object B according to an embodiment of the present invention;

FIG. 3 is a process diagram of file sharing when a user A chats with a target object B according to an embodiment of the present invention;

FIG. 4 is a process diagram of file sharing when a user A chats with a target object B according to another embodiment of the present invention;

FIG. 5 is a process diagram when a user A shares a file with a target object B1 and a target object B2 in a same chat box according to an embodiment of the present invention;

FIG. 6 is a process diagram when a user A shares a file with a target object B1 and a target object B2 in a same chat box according to another embodiment of the present invention; and

FIG. 7 is a process diagram when a user A shares files with a target object B1 and a target object B2 separately in two chat boxes according to another embodiment of the present invention.

### DETAILED DESCRIPTION

To make the objectives, technical solutions, and advantages of the present application clearer, the following clearly and completely describes the technical solutions of the present application with reference to specific embodiments and corresponding accompanying drawings of the present application. Apparently, the described embodiments are only some embodiments rather than all the embodiments of the present application. All other embodiments obtained by persons of ordinary skill in the art based on the embodiments of the present invention without making creative efforts shall fall within the protection scope of the present invention.

The technical solutions provided in the embodiments of the present disclosure are described in detail below with reference to the accompanying drawings.

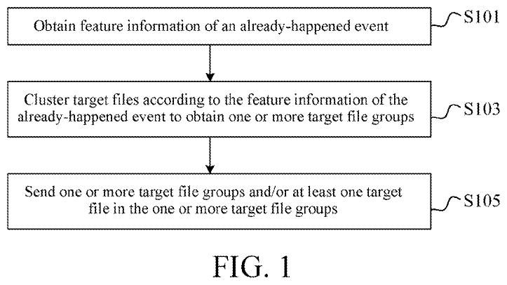

An embodiment of the present invention provides a file sharing method. Specifically, FIG. 1 is a flowchart of a file sharing method according to an embodiment of the present invention. The method includes the following steps: obtaining feature information of an already-happened event, as shown in step S101 of FIG. 1; clustering target files according to the feature information of the already-happened event to obtain one or more target file groups, as shown in step S103 of FIG. 1, where each target file group includes at least one target file; and sending at least one target file group and/or at least one target file in the one or more target file groups, as shown in step S105 of FIG. 1.

In an embodiment of the present invention, in step S101, the obtaining feature information of an already-happened event includes: obtaining feature information of a target object. The feature information of the target object includes, but not limited to, one or more of identity information of the target object and summary information determined from content of an already-happened chat with the target object. That is, the feature information of the target object may include only the identity information of the target object, or include only the summary information determined from the content of the already-happened chat with the target object, or the feature information of the target object may include both the identity information of the target object and the summary information determined from the content of the already-happened chat with the target object. It should be noted that, in another embodiment of the present invention, the feature information of the target object is not limited thereto, which may include other attribute information of the target object according to an actual need.

For example, when a user A chats with a target object B by using the file sharing method in this embodiment of the present invention, identity information of the target object B and summary information of content of the chat with the target object B are obtained. Specifically, before the chat with the target object B starts, as there is no chat content, only the identity information of the target object B is obtained as feature information of the target object B. After the chat with the target object B starts, a set of the identity information of the target object B and the summary information of the content of the chat with the target object B needs to be obtained as the feature information of the target object B. Certainly, the summary information of the content of the chat with the target object B may be independently used as the feature information of the target object B.

The identity information of the target object B includes, but not limited to, account information registered with an application for chatting and identity information of a user using the account information. For example, in WeChat, a WeChat account of the target object B is tiantianl, and a user using the account is Li Tian. Then the identity information of the target object B includes, but not limited to, tiantianl, Li Tian, a relationship between the user A and Li Tian, and the like.

Next, in step S103, target files are clustered according to the feature information of the already-happened event to obtain one or more target file groups, where each target file group includes at least one target file. Specifically, in an embodiment of the present invention, when there are a plurality of target objects and chats with the plurality of target objects happen separately, the target files are clustered according to feature information of the target objects at different times. That is, when the chats with the plurality of target objects happen separately, the target files are clustered for the plurality of target objects at different times. For a specific target object, the target files are clustered in real time according to feature information of the target object.

For example, when a user A separately chats with a target object B1 and a target object B2, that is, the user A chats with the target object B2 while chatting with the target object B1, and the user A switches between a chat window with the target object B1 and a chat window with the target object B2. The target files are clustered according to feature information of the target object B1 and the target object B2 at different times in processes of chatting with the target object B1 and the target object B2. That is, the target files may be clustered in the two windows at different times according to feature information of target objects corresponding to respective windows.

Further, in the chat window between the user A and the target object B1, the target files are clustered in real time according to feature information of the target object B1 (one or more of identity information of B1 and summary information of content of the chat with chat B1). In the chat window between the user A and the target object B2, the target files are clustered in real time according to feature information of the target object B2 (one or more of identity information of B2 and summary information of content of the chat with chat B2).

In another embodiment of the present invention, when chats with the plurality of target objects happen simultaneously, the target files are clustered in real time according to feature information of all the target objects.

For example, when a user A chats with a target object B1 and a target object B2 simultaneously, that is, the user A has a group chat with the target object B1 and the target object B2, and the user A, the target object B1, and the target object B2 are in a same chat window, the target files are clustered in real time according to feature information of a target object set including the target object B1 and the target object B2.

Further, in an embodiment of the present invention, when chats with the plurality of target objects happen simultaneously, feature information of the target objects is obtained, then a set of the feature information of all the target objects is obtained, and the target files are clustered in real time according to the set of the feature information of all the target objects.

For example, in the foregoing example, when the user A has a group chat with the target object B1 and the target object B2 in a same chat window, a target object set includes all the target objects, that is, a target object set includes the target object B1 and the target object B2. Feature information of each target object in the target object set is obtained, that is, feature information of each of the target object B1 and the target object B2 is obtained. Then common feature information of all the target objects in the target object set is obtained, that is, common feature information of the target object B1 and the target object B2 is obtained, which is the feature information of the target object set. The target files are clustered in real time according to the common feature information of the target object B1 and the target object B2. In other words, an intersection of the feature information of the target object B1 and the target object B2 is used as the feature information of the target object set, and then the target files are clustered in real time according to the intersection of the feature information of the target object B1 and the target object B2.

In another embodiment of the present invention, when chats with the plurality of target objects happen simultaneously, feature information of the target objects is obtained, and then common feature information of all the target objects is obtained, and then the target files are clustered in real time according to the common feature information of all the target objects.

Specifically, in the foregoing example that the user A has a group chat with the target object B1 and the target object B2 in a same chat window, after feature information of the target object B1 and the target object B2 is obtained, a set of the feature information of the target object B1 and the target object B2 is used as the feature information of the target object set. That is, a union of the feature information of the target object B1 and the target object B2 is used as the feature information of the target object set. Then the target files are clustered in real time according to the set of the feature information of the target object B1 and the target object B2. In other words, the target files are clustered in real time according to the union of the feature information of the target object B1 and the target object B2.

In step S105, at least one target file group and/or at least one target file in the one or more target file groups is sent.

Specifically, the one or more target file groups obtained in step S103 is first displayed, then at least one target file group and/or at least one target file is obtained from the one or more target file groups, and finally the obtained at least one target file group and/or at least one target file is sent.

Specifically, in an embodiment of the present invention, a user may obtain a target file through a single selection operation, and may also obtain a target file group through a single selection operation. Particularly, when a target file group includes a plurality of target files, the user can select all the target files in the target file group through a single operation. This simplifies operations for the user and improves operation experience of the user.

In an embodiment of the present invention, when the one or more target file groups obtained through the clustering in step S103 needs to be displayed, a sharing request is generated, and the obtained one or more target file groups are displayed according to the sharing request.

In an embodiment of the present invention, after the sharing request is generated, the one or more target file groups that are obtained by clustering the target files according to the feature information of the already-happened event are obtained from a cache based on the sharing request.

In this embodiment, when the user A chats with the target object B (or the target object set of the target object B1 and the target object B2), the target files are clustered in real time according to the summary information of the content of the chat with the target object B or the identity information of the target object B to obtain the one or more target file groups, then the obtained one or more target file groups are stored in the cache, and after the sharing request is generated, the clustered one or more target file groups are directly obtained from the cache. The user A would not feel the clustering process, and user experience is better. However, use of the file sharing method in this embodiment of the present invention poses a higher configuration requirement to a terminal device.

In another embodiment of the present invention, after the sharing request is generated, the target files are further clustered based on the sharing request according to the feature information of the already-happened event. For example, when a user A chats with a target object B, feature information of the target object B is extracted only, and the target files are not clustered according to the feature information of the target object B. After a sharing request is generated, the target files are clustered based on the sharing request according to the feature information of the target object B.

After the target files are clustered according to the feature information of the already-happened event, obtained one or more target file groups are displayed. Then at least one target file or at least one target file group is selected from the displayed one or more target file groups. A quantity of target files included in each target file group is less than or equal to a preset value. In this embodiment of the present invention, the preset value is an integer greater than or equal to 2. In an embodiment of the present invention, the preset value may be 2, 3, 4, 6, 9, or the like, which may be adjusted according to an actual need. The preset value is not the core of the present invention, and the present invention is not limited thereto. In an embodiment of the present invention, the preset value is 3 for example.

The one or more target file groups obtained after the clustering are displayed, and each target file group includes at least one target file, but not more than three target files.

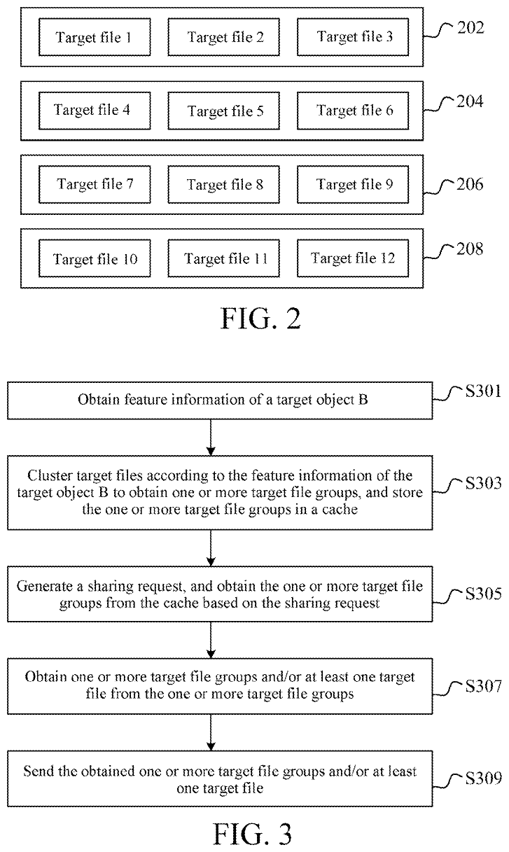

In the foregoing example that the user A chats with the target object B, the target files are clustered according to the feature information of the target object B and four target file groups are obtained, as shown in FIG. 2. FIG. 2 is a schematic diagram of a clustering result when the user A chats with the target object B according to an embodiment of the present invention. The four target file groups are a first target file group 202, a second target file group 204, a third target file group 206, and a fourth target file group 208. Each target file group includes three target files. The user A may select a target file or a target file group in the four target file groups through a single selection operation, that is, may select all of threes target files in a target file group through a single selection operation. Further, the user may select a combination of a target file group and a target file through a plurality of selection operations. In this embodiment, the user A selects the first target file group 202 and a target file (a target file 8) in the third target file group 206.

Next, after the at least one target file or the at least one target file group is determined, the determined at least one target file group and/or at least one target file is sent, as shown in step S105 of FIG. 1.

In the foregoing example that the user A chats with the target object B, the user A sends three target files (a target file 1, a target file 2, and a target file 3) in the selected first target file group 202 and the selected target file (the target file 8) in the third target file group 206.

In another embodiment of the present invention, the obtaining feature information of an already-happened event further includes: obtaining feature information from an already-happened transaction, or obtaining feature information from the target files.

Specifically, when a WeChat user A intends to post target files in Moments, feature information may be obtained from a transaction performed by another application on a terminal device on which the user A logs in. For example, an air or train ticket from Beijing to Shanghai was bought by using another application on the terminal device on which the user A logs in. Then feature information “Beijing” and “Shanghai” may be obtained from the already-happened event. When the user A intends to post a moment, the target files are clustered according to the feature information (“Beijing” and “Shanghai”) of the already-happened event.

In another embodiment of the present invention, feature information may be obtained from the target files. For example, when a WeChat user A intends to post target files in Moments, feature information of the target files is first obtained, and then the target files are clustered according to the feature information of the target files.

The feature information of the target file includes, but not limited to, one or more of a generation time, summary information, a geographic location of generation, a historical transmission time, a historical transmission object, and an application that transmits the target file. The generation time is a time at which the target file is formed. The geographic location of generation is a geographic location of a terminal device generating the target file. When the target file was shared, the historical transmission time is a time at which the target file was shared, the historical transmission object is an object the target file was shared with, and the application that transmits the target file is a means of sharing the target file. For example, the target file may be shared by using QQ, DingTalk, or other instant messaging programs, or may be shared by using an email.

In an embodiment of the present invention, descriptions are provided by using an example of a scenario in which in a same application, a user A chats and shares a target file with a target object B, and then chats and shares a target file with a target object C. After the user A shares the target file with the target object B in a chat process, as the target file is shared by using the application, feature information of the target file includes a historical transmission time, a historical transmission object (in this embodiment, the transmission object is the target object B), and the application that transmits the target file (which is an application used by the user A to chat with the target object B and the target object C in this embodiment).

For example, when the user A chats with the target object B, target files are clustered and three target file groups are obtained, and the user A selects and shares a second target file group.

Next, when the user A chats with the target object C, feature information of an already-happened event according to which the target files are clustered includes: feature information of the target object C and feature information of the target object B. Therefore, obtained one or more target file groups include the target file shared when the user A chats with the target object B. In other words, when the user A shares the target file with the target object C in a chat process, target file groups obtained by clustering the target files include the second target file group the user A shared with the target object B.

It should be noted that, in this embodiment of the present invention, the target file includes, but not limited to, one or more of a picture, a photo, and a video. The terminal device on which the user A logs in includes, but not limited to, an electronic device such as a smartphone, a tablet computer, and a personal computer.

Next, an implementation process of the file sharing method provided in this embodiment of the present invention is described by using an example of a scenario in which a user A chats with a target object B. Specifically, FIG. 3 is a process diagram of file sharing between the user A and the target object B according to an embodiment of the present invention. First, step S301: Obtain feature information of the target object B. The feature information of the target object B includes one or more of identity information of the target object B and summary information of content of the chat between the user A and the target object B. In this embodiment, the feature information of the target object B includes both the identity information of the target object B and the summary information of the content of the chat between the user A and the target object B.

Then, as shown in step S303 of FIG. 3: Cluster target files according to the feature information of the target object B to obtain one or more target file groups, and store the one or more target file groups in a cache.

Step S305: Generate a sharing request, and obtain the one or more target file groups from the cache based on the sharing request.

Step S307: Obtain at least one target file group and/or at least one target file from the one or more target file groups.

Step S309: Send the at least one target file group and/or the at least one target file obtained in step S307.

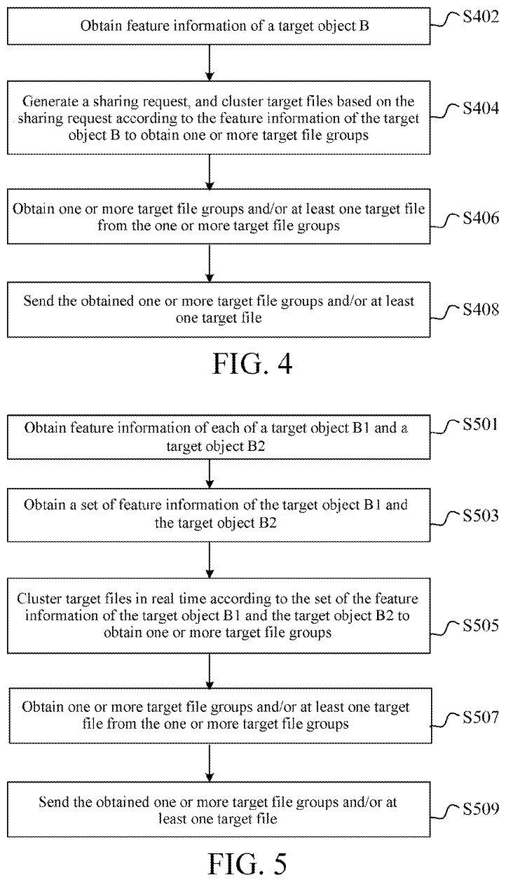

In another embodiment of the present invention, the scenario in which the user A chats with the target object B is still used as an example. As shown in FIG. 4, first, as shown in step S402 of FIG. 4: Obtain feature information of the target object B. The feature information of the target object B includes one or more of identity information of the target object B and summary information of content of the chat between the user A and the target object B. In this embodiment, the feature information of the target object B includes both the identity information of the target object B and the summary information of the content of the chat between the user A and the target object B.

Step S404: Generate a sharing request, and cluster target files based on the sharing request according to the feature information of the target object B to obtain one or more target file groups.

Step S406: Obtain at least one target file group and/or at least one target file from the one or more target file groups.

Step S408: Send the at least one target file group and/or the at least one target file obtained in step S406.

In another embodiment of the present invention, for example, a user A chats with a target object B1 and a target object B2 in a same chat box. As shown in FIG. 5, step S501: Obtain feature information of each of the target object B1 and the target object B2.

Step S503: Obtain a set of feature information of the target object B1 and the target object B2.

Step S505: Cluster target files in real time according to the set of the feature information of the target object B1 and the target object B2 to obtain one or more target file groups.

Step S507: Obtain at least one target file group and/or at least one target file from the one or more target file groups.

Step S509: Send the at least one target file group and/or the at least one target file obtained in step S507.

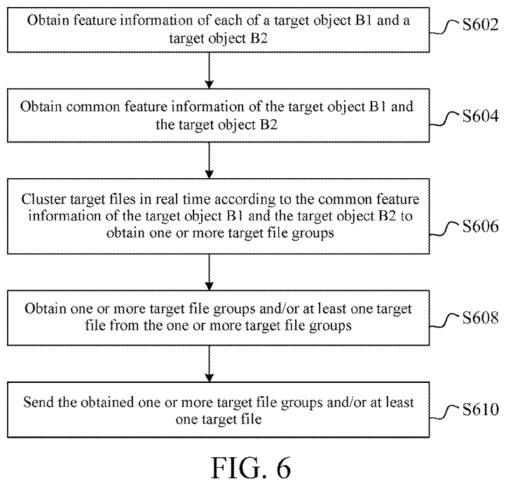

In another embodiment of the present invention, for example, a user A chats with a target object B1 and a target object B2 in a same chat box. As shown in FIG. 6, step S602: Obtain feature information of each of the target object B1 and the target object B2.

Step S604: Obtain common feature information of the target object B1 and the target object B2.

Step S606: Cluster target files in real time according to the common feature information of the target object B1 and the target object B2 to obtain one or more target file groups.

Step S608: Obtain at least one target file group and/or at least one target file from the one or more target file groups.

Step S610: Send the at least one target file group and/or the at least one target file obtained in step S608.

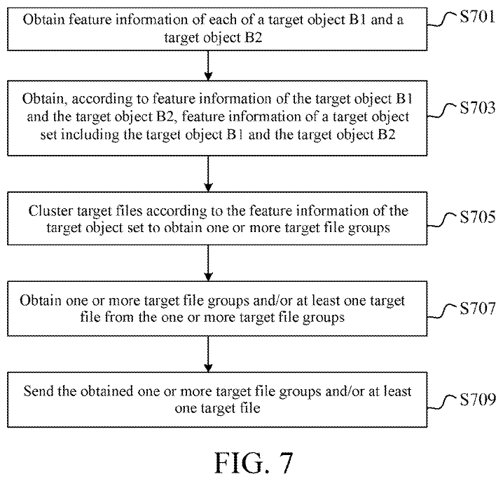

In another embodiment of the present invention, for example, a user A chats with a target object B1 and a target object B2 separately in two chat boxes. As shown in FIG. 7, step S701: Obtain feature information of each of the target object B1 and the target object B2.

Step S703: Obtain, according to feature information of the target object B1 and the target object B2, feature information of a target object set including the target object B1 and the target object B2.

Step S705: Cluster target files according to the feature information of the target object set to obtain one or more target file groups.

Step S707: Obtain at least one target file group and/or at least one target file from the one or more target file groups.

Step S709: Send the at least one target file group and/or the at least one target file obtained in step S707.

Based on a same invention idea, an embodiment of the present disclosure provides a computer readable medium, storing a computer readable instruction, where the computer readable instruction is executed by a processor to perform the following steps:

obtaining feature information of an already-happened event;

clustering target files according to the feature information of the already-happened event to obtain one or more target file groups, where each target file group includes at least one target file; and

sending at least one target file group and/or at least one target file in the one or more target file groups.

An embodiment of the present invention further provides a device for processing information at a user equipment end, including a memory configured to store a computer program instruction and a processor configured to execute the program instruction, where when executed by the processor, the computer program instruction triggers the device to perform the following steps:

obtaining feature information of an already-happened event;

clustering target files according to the feature information of the already-happened event to obtain one or more target file groups, where each target file group includes at least one target file; and

sending at least one target file group and/or at least one target file in the one or more target file groups.

The at least one technical solution used in the embodiments of the present disclosure can achieve the following beneficial effects: Target files are clustered according to feature information of an already-happened event to obtain one or more target file groups, so that a target file in the one or more target file groups is related to the already-happened event. Then a target file or a target file group to be sent is determined from the target file groups obtained through the clustering. In this way, a user can quickly select a target file related to the already-happened event, which enhances fun of user interaction and improves user experience. In addition, all target files in a target file group can be directly selected through a single operation, which simplifies operations for the user to select the target files, saves time for the user, and further improves user experience.

In the 1990s, improvements of a technology can be clearly distinguished between hardware improvements (for example, improvements to a circuit structure such as a diode, a transistor, a switch, etc.) and software improvements (improvements to a method procedure). However, with the development of technology, improvements of many method procedures can be considered as direct improvements of hardware circuit structures. Designers almost all program an improved method procedure to a hardware circuit, to obtain a corresponding hardware circuit structure. Therefore, it does not mean that the improvement of a method procedure cannot be implemented by using a hardware entity module. For example, a programmable logic device (PLD) such as a field programmable gate array (FPGA) is a type of integrated circuit whose logic function is determined by a user by programming the device. For example, a programmable logic device (PLD) such as a field programmable gate array (FPGA) is a type of integrated circuit whose logic function is determined by a user by programming the device. Moreover, nowadays, instead of manually making integrated circuit chips, this programming is mostly implemented by using “logic compiler” software, which is similar to the software compiler used in program development and writing. The original code is written in a specific programming language before compiling, and this language is referred to as a hardware description language (HDL). There are various kinds of HDLs, for example, advanced boolean expression language (ABEL), altera hardware description language (AHDL), Confluence, cornell university programming language (CUPL), HDCal, Java hardware description language (JHDL), Lava, Lola, MyHDL, PALASM, Ruby hardware description language (RHDL), and the like. Currently, the most commonly used HDLs are very-high-speed integrated circuit hardware description language (VHDL) and Verilog. A person skilled in the art should also understand that as long as a method procedure is logically programmed and then programmed to an integrated circuit by using the foregoing hardware description languages, a hardware circuit that implements the logical method procedure can be easily obtained.

The controller can be implemented in any suitable manner, for example, the controller can take the form of, for example, a microprocessor or processor and a computer readable medium storing computer readable program code (for example, software or firmware) executable by the processor, a logic gate, a switch, an application-specific integrated circuit (ASIC), a programmable logic controller and an embedded microcontroller. Examples of the controller include, but are not limited to, the following microcontrollers: ARC 625D, Atmel AT91SAM, Microchip PIC18F26K20 and Silicone Labs C8051F320. The memory controller can also be implemented as part of the memory control logic. A person skilled in the art will also appreciate that, in addition to implementing the controller in the form of pure computer readable program code, it is also possible to implement the controller in the form of a logic gate, switch, application-specific integrated circuit, programmable logic controller, and embedded microcontroller and other forms to achieve the same function. Such a controller can thus be considered as a hardware component and apparatuses included therein for implementing various functions can also be considered as structures inside the hardware component. Alternatively, apparatuses configured to implement various functions can be considered as both software modules implementing the method and structures inside the hardware component.

The system, the apparatus, the module or the unit described in the foregoing embodiments can be specifically implemented by a computer chip or an entity or implemented by a product having a certain function. A typical implementation device is a computer.

Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, when the apparatus is described, the apparatus is divided into units according to functions, which are separately described. Certainly, in implementation of the present application, the function of the units may be implemented in a same piece of or multiple pieces of software and/or hardware.

A person skilled in the art should understand that the embodiments of the present invention may be provided as a method, a system, or a computer program product. Therefore, the embodiments of the present invention may use a form of hardware only embodiments, software only embodiments, or embodiments with a combination of software and hardware. Moreover, the embodiments of the present invention may use a form of a computer program product that is implemented on one or more computer-usable storage media (including but not limited to a disk memory, a CD-ROM, an optical memory, and the like) that include computer-usable program code.

The present invention is described with reference to the flowchart and/or block diagram of the method, device (system), and computer program product of the embodiments of the present invention. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the general-purpose computer or the processor of another programmable data processing device.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the other programmable devices, thereby generating computer-implemented processing. Therefore, the instructions executed on the computer or the another programmable device provide steps for implementing a specific function in one or more processes in the flowcharts and/or in one or more blocks in the block diagrams.

In a typical configuration, the computer device includes one or more processors (CPUs), an input/output interface, a network interface, and a memory.

The memory may include a form such as a persistent memory, a random-access memory (RAM) and/or a non-volatile memory of computer readable media, for example, a read-only memory (ROM) or a flash memory (RAM). The memory is an example of the computer readable medium.

The computer readable medium includes a persistent medium and a non-persistent medium, a removable medium and a non-removable medium, which may implement storage of information by using any method or technology. The information may be a computer readable instruction, a data structure, a module of a program or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition in the present disclosure, the computer readable medium does not include transitory computer readable media (transitory media), such as a modulated data signal and a carrier.

It should also be noted that the terms “include”, “comprise” and any other variants mean to cover the non-exclusive inclusion. Thereby, the process, method, article, or device which include a series of elements not only include those elements, but also include other elements which are not clearly listed, or include the inherent elements of the process, method, article and device. Without further limitation, the element defined by a phrase “include one” does not exclude other same elements in the process, method, article or device which include the element.

The present application can be described in the general context of computer-executable instructions executed by a computer, for example, a program module. Generally, the program module includes a routine, a program, an object, a component, a data structure, and the like for executing a particular task or implementing a particular abstract data type. The present application may also be practiced in distributed computing environments in which tasks are performed by remote processing devices that are connected by using a communications network. In a distributed computing environment, the program module may be located in both local and remote computer storage media including storage devices.

The embodiments of the present disclosure are all described in a progressive manner, for same or similar parts in the embodiments, refer to these embodiments, and descriptions of each embodiment focus on a difference from other embodiments. Especially, a system embodiment is basically similar to a method embodiment, and therefore is described briefly; for related parts, reference may be made to partial descriptions in the method embodiment.

The foregoing descriptions are merely embodiments of the present application and are not intended to limit the present application. For a person skilled in the art, various modifications and variations can be made to the present application. Any modification, equivalent replacement, or improvement made without departing from the spirit and principle of the present application shall fall within the scope of the claims of the present application.

What is claimed is:

1. A file sharing method, comprising:
obtaining feature information of an already-happened event;
clustering target files according to the feature information of the already-happened event to obtain one or more target file groups, wherein each target file group of the one or more target file groups comprises at least one target file; and
sending at least one target file group and/or one or more target files in the one or more target file groups.

2. The file sharing method according to claim 1, wherein, the step of obtaining the feature information of the already-happened event comprises:
obtaining feature information of a target object, wherein
the feature information of the target object comprises one or more selected from the group consisting of identity information of the target object and summary information, wherein the summary information is determined from a content of an already-happened chat with the target object.

3. The file sharing method according to claim 2, wherein, the step of clustering the target files according to the feature information of the already-happened event comprises:
when there are a plurality of target objects and chats with the plurality of target objects happen separately,
clustering the target files according to feature information of the plurality of target objects at different times.

4. The file sharing method according to claim 2, wherein, the step of clustering the target files according to the feature information of the already-happened event comprises:
when there are a plurality of target objects and chats with the plurality of target objects happen simultaneously,
clustering the target files in real time according to feature information of the plurality of target objects.

5. The file sharing method according to claim 4, wherein, the step of clustering the target files in real time according to the feature information of the plurality of target objects comprises:
obtaining the feature information of the plurality of target objects;
obtaining a set of the feature information of the plurality of target objects; and
clustering the target files in real time according to the set of the feature information of the plurality of target objects.

6. The file sharing method according to claim 4, wherein, the step of clustering the target files in real time according to the feature information of the plurality of target objects comprises:
obtaining the feature information of the plurality of target objects;
obtaining common feature information of the plurality of target objects; and
clustering the target files in real time according to the common feature information of the plurality of target objects.

7. The file sharing method according to claim 1, wherein, before the step of sending the at least one target file group and/or the one or more target files in the one or more target file groups, the file sharing method further comprises:
generating a sharing request; and
obtaining, from a cache based on the sharing request, the one or more target file groups.

8. The file sharing method according to claim 1, wherein, the step of clustering the target files according to the feature information of the already-happened event comprises:
generating a sharing request; and
clustering the target files based on the sharing request according to the feature information of the already-happened event.

9. The file sharing method according to claim 1, wherein, before the step of sending the at least one target file group and/or the one or more target files in the one or more target file groups, the file sharing method further comprises:
obtaining the at least one target file group and/or the one or more target files from the one or more target file groups.

10. The file sharing method according to claim 9, wherein, the step of sending the at least one target file group and/or the one or more target files in the one or more target file groups comprises:
for a target file in the at least one target file, obtaining the target file from the one or more target file groups through a single selection operation;
or
for a target file group in the at least one target file group, obtaining the target file group from the one or more target file groups through the single selection operation.

11. The file sharing method according to claim 1, wherein, the step of obtaining the feature information of the already-happened event comprises: obtaining feature information from an already-happened transaction.

12. The file sharing method according to claim 1, wherein, the step of obtaining the feature information of the already-happened event comprises: obtaining feature information from the target files.

13. The file sharing method according to claim 12, wherein, the feature information obtained from the target files comprises one or more selected from the group consisting of a generation time, summary information, a geographic location of a generation, a historical transmission time, a historical transmission object, and an application, wherein the application transmits the target files.

14. A computer readable medium, comprising a computer readable instruction stored in the computer readable medium, wherein, the computer readable instruction is executed by a processor to implement the file sharing method according to claim 1.

15. A device for processing information at a user equipment end, comprising:
a memory, configured to store a computer program instruction, and
a processor, configured to execute the computer program instruction;
wherein
when the computer program instruction is executed by the processor, the device is triggered by the computer program instruction to perform the file sharing method according to claim 1.

16. The computer readable medium according to claim 14, wherein, the step of obtaining the feature information of the already-happened event comprises:
obtaining feature information of a target object, wherein
the feature information of the target object comprises one or more selected from the group consisting of identity information of the target object and summary information, wherein the summary information is determined from a content of an already-happened chat with the target object.

17. The computer readable medium according to claim 16, wherein, the step of clustering the target files according to the feature information of the already-happened event comprises:
when there are a plurality of target objects and chats with the plurality of target objects happen separately,
clustering the target files according to feature information of the plurality of target objects at different times.

18. The computer readable medium according to claim 16, wherein, the step of clustering the target files according to the feature information of the already-happened event comprises:
when there are a plurality of target objects and chats with the plurality of target objects happen simultaneously,
clustering the target files in real time according to feature information of the plurality of target objects.

19. The computer readable medium according to claim 18, wherein, the step of clustering the target files in real time according to the feature information of the plurality of target objects comprises:
obtaining the feature information of the plurality of target objects;
obtaining a set of the feature information of the plurality of target objects; and
clustering the target files in real time according to the set of the feature information of the plurality of target objects.

20. The computer readable medium according to claim 18, wherein, the step of clustering the target files in real time according to the feature information of the plurality of target objects comprises:
obtaining the feature information of the plurality of target objects;
obtaining common feature information of the plurality of target objects; and
clustering the target files in real time according to the common feature information of the plurality of target objects.
